(19) United States
(12) Patent Application Publication
(10) Pub. No.: US 2012/0311981 A1
(43) Pub. Date: Dec. 13, 2012

(54) Air Filter Device

(76) Inventors: Hou-Huan Lin, Taichung City (TW); Chih-Yi Wu, Chiayi City (TW); Pei-Yin Chen, Yilan County (TW)

(21) Appl. No.: 13/157,553

(22) Filed: Jun. 10, 2011

(51) Int. Cl. B01D 46/52

(52) U.S. Cl. 55/499

(57) ABSTRACT

An air filter device includes an air filter medium, a base including a surrounding wall that has first and second ends and that defines a receiving space, and a loop-shaped retainer that engages removably the second end of the surrounding wall. The receiving space of the base is open at the first and second ends of the surrounding wall, and the air filter medium is placed removably in the receiving space. The first end of the surrounding wall is configured to support one side of the air filter medium, and the loop-shaped retainer is disposed to abut against another side of the air filter medium in the receiving space.

### BACKGROUND OF THE INVENTION

1. Field of the Invention

This invention an air filter device and a housing for an air filter medium.

2. Description of the Related Art

Referring to FIG. 1, a conventional air filter device 1 comprises a base 11 and a corrugated air filter medium 12. The base 11 includes a surrounding wall 111 that defines a receiving space 110 therein, and a plurality of beams 112 connected to a bottom end of the surrounding wall 111. When in use, the air filter medium 12 is received in the receiving space 110 and is supported by the beams 112 of the base 11. The periphery of the air filter medium 12 is adhered to an inner surface of the surrounding wall 111 using an adhesive for ensuring that the air filter medium 12 is stably disposed in the receiving space 110 and for preventing air leakage between the air filter medium 12 and the surrounding wall 111 of the base 11.

The air filter medium 12 is used for refreshing air and deodorization, and as a consequence, would be gradually stuck with dust and impurities and become ineffective in air filtration. Since the air filter medium 12 is adhered to the base 11, the air filter device 1 must be discarded entirely while in fact merely the air filter medium 12 is consumed and needs replacement. In other words, the air filter medium 12 is not replaceable with regard to the air filter device 1, thereby resulting in wastefulness and an increase in maintenance costs of the air filter device 1. Moreover, the adhesive used between the base 11 and air filter medium 12 may deteriorate, thereby eventually resulting in air leakage therebetween.

### SUMMARY OF THE INVENTION

Therefore, the object of the present invention is to provide an air filter device that includes a replaceable air filter medium and that has superior filtration efficiency.

According to one aspect of the present invention, an air filter device comprises: an air filter medium; a base including a surrounding wall that has first and second ends and that defines a receiving space, the receiving space being open at the first and second ends the surrounding wall, the air filter medium being placed removably in the receiving space, the first end of the surrounding wall being configured to support one side of the air filter medium; and a loop-shaped retainer that engages removably the second end of the surrounding wall and that is disposed to abut against another side of the air filter medium in the receiving space.

According to a second aspect of the present invention, an air filter device comprises: an filter medium; a base including a surrounding wall that has first and second ends and that defines a receiving space, the receiving space being open at the first and second ends of the surrounding wall, the air filter medium being placed removably in the receiving space; and a loop-shaped retainer including a loop-shaped frame that engages removably the second end of the surrounding wall, and a sealing strip fitted between the loop-shaped frame and the surrounding wall.

According to a third aspect of the present invention, a housing for an air filter medium comprises: a base including a surrounding wall that has first and second ends and that defines a receiving space, the receiving space being open at the first and second ends of the surrounding wall and being adapted for placing the air filter medium therein; and a loop-shaped retainer including a loop-shaped frame that engages removably the second end of the surrounding wall, and a sealing strip fitted between the loop-shaped frame and the surrounding wall.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view conventional air filter device;

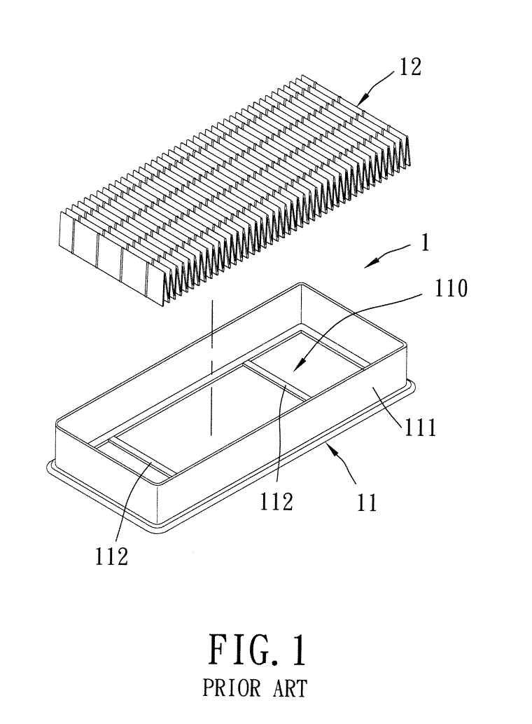

FIG. 2 is an exploded perspective view of the first preferred embodiment of an air filter device according to this invention;

FIG. 3 is a partly sectional view of the first embodiment shown in FIG. 2;

FIG. 4 is an exploded perspective view of the second preferred embodiment of an air filter device according this invention;

FIG. 5 is an exploded and partly sectional view of the second preferred embodiment shown in FIG. 4;

FIG. 6 is a partly sectional view of the second preferred embodiment shown in FIG. 4;

FIG. 7 is an exploded perspective view of the third preferred embodiment of an air filter device according to this invention; and

FIG. 8 is a fragmentary and partly sectional view of the fourth preferred embodiment of an air filter device according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

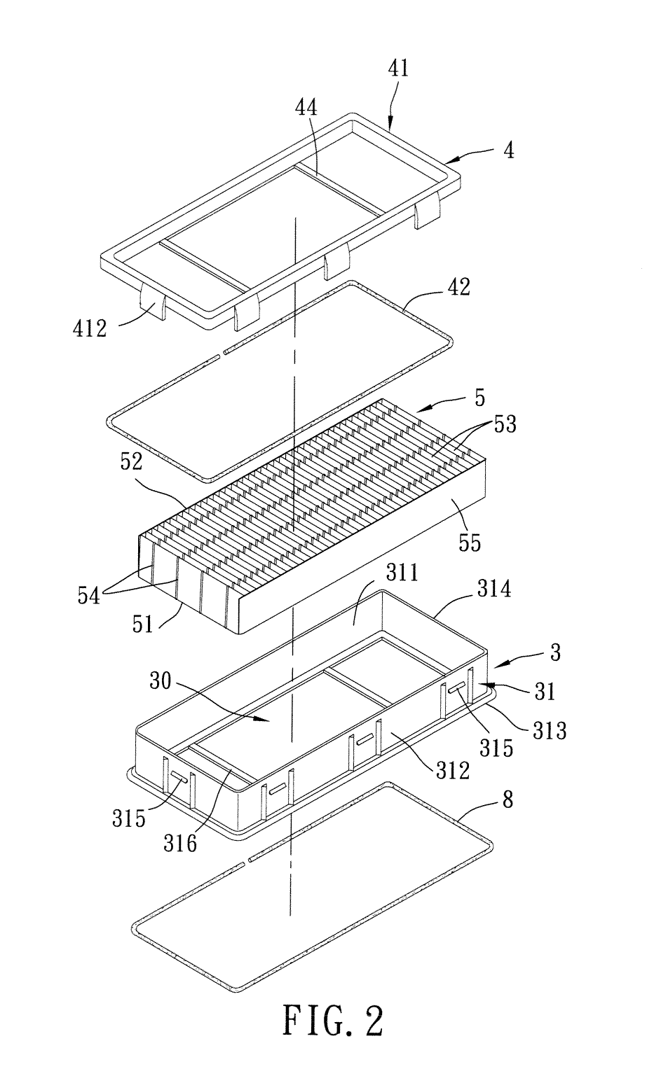

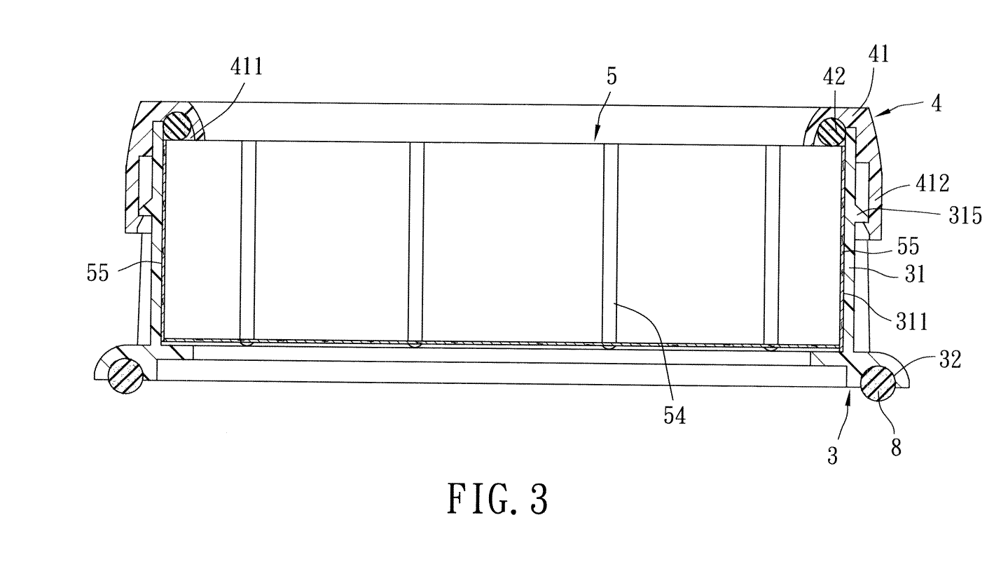

Referring to FIGS. 2 and 3, the first preferred embodiment of an air filter device of this invention comprises a base 3, a loop-shaped retainer 4, and an air filter medium 5.

The base 3 includes a surrounding wall 31 that has inner and outer surfaces 311, 312, and first and second ends 313, 314, and that defines a receiving space 30 being open at the first and second ends 313, 314. The outer surface 312 of the base 3 is formed with a plurality or protrusions 315.

The loop-shaped retainer 4 includes a loop-shaped frame 41 formed with an insert groove 411 and a plurality of resilient anchoring members 412, and a sealing strip 42. The insert groove 411 opens toward the surrounding wall 31 of the base 3 and has the sealing strip 42 received therein. The loop-shaped frame 41 engages removably the second end 314 of the surrounding wall 31 such that the second end 314 of the surrounding wall 31 presses against the sealing strip 42. The sealing strip 42 is thus fitted between the loop-shaped frame 41 and the surrounding wall 31. The resilient anchoring members 412 engage removably and respectively the protrusions 315 of the base 3.

It should be noted that the protrusions 315 and the resilient anchoring members 412 may be formed interchangeably, i.e., the protrusions 315 may be formed on the loop-shaped frame 41 and the resilient anchoring members 412 may be formed on the base 3. Alternatively, the loop-shaped frame 41 may engage the base 3 using a pivot joint in place of the protrusions 315 and the resilient anchoring members 412.

The air filter medium 5 is placed removably in the receiving space 30 of the base 3 and has first and second sides 51, 52. The first end 313 of the surrounding wall 31 of the base 3 is configured to support the first side 51 of the air filter medium 5. The loop-shaped retainer 4 is disposed to abut against the second side 52 of the air filter medium 5 so as to retain the air filter medium 5 inside the base 3. Optionally, the surrounding wall of the base 3 may further include a plurality of base beams 316 formed between two sides of the first end of the surrounding wall 31 for providing support to the air filter medium 5. Similarly, the loop-shaped frame 41 of the loop-shaped retainer 4 may further include a plurality of retaining beams 44 formed between two sides of the loop-shaped frame 41 to help stably retain the air filter medium 5 in the base 3.

Preferably, the air filter medium 5 is a corrugated filter medium having a plurality of interconnected folded parts 53. In the first preferred embodiment, the air filter medium 5 further has two side strips 55 connected to two opposite edges of the interconnected folded parts 53, and a plurality of sustaining strips 54 that are separately formed on a top surface of the air filter medium 5 that are preferably made from a flexible material. When the air filter medium 5 is disposed inside the base 3, each of the side strips 55 abuts against the inner surface 311 of the base 3 so that the base 3 is stuffed with the air filter medium 5. The corrugated air filter medium 5 may be maintained in a stretched state by the two side strips 55 and the sustaining strips 54 such the interconnected folded parts 53 are disposed apart from each other. The air filter medium 5 may be made from any suitable material known to those skilled in the art.

Optionally, the air filter device of this invention may further comprise an abutting strip 6 disposed beneath the base 3. The second end 313 of the base 3 is formed with a base groove 32 that opens toward the bottom of the base 3 and that has the abutting strip 8 received therein.

In use, the air filter medium 5 is disposed in the receiving space 30 of the base 3, with the side strips 55 of the air filter medium 5 abutting against the inner surface 311 of the base 3 and the air filter medium 5 being in a stretched state. The sealing strip 42 is disposed in the insert groove 411 of the loop-shaped retainer 4, followed by engaging the loop-shaped retainer 4 with the second end 314 of the surrounding wall 31 through the resilient anchoring members 412 of the loop-shaped retainer 4 and the protrusions 315 of the base 3. Upon engagement, the second end 314 of the surrounding wall 31 may extend into the insert groove 411 such that the inner surface 311 near the second end 314 of the surrounding wall 31 presses against the sealing strip 42. Therefore, the sealing strip 42 is fitted in the insert groove 411 between the loop-shaped frame 41 and the surrounding wall 31, and abuts against the second side 52 of the air filter medium 5, thereby preventing air leakage among the sealing strip 42, the loop-shaped frame 41 of the loop-shaped retainer 4, and the surrounding wall 31 the base 3, as well as improving filtration efficiency of the air filter device. In addition, the air filter device or this invention is environmental friendly and the maintenance costs thereof are reduced because of the design of the replaceable air filter medium 5.

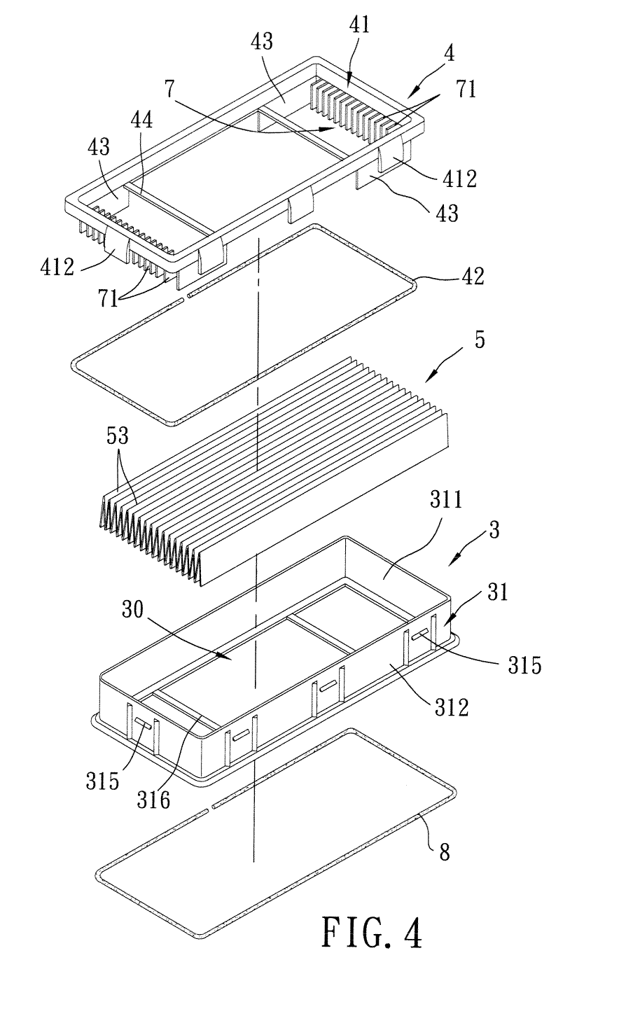

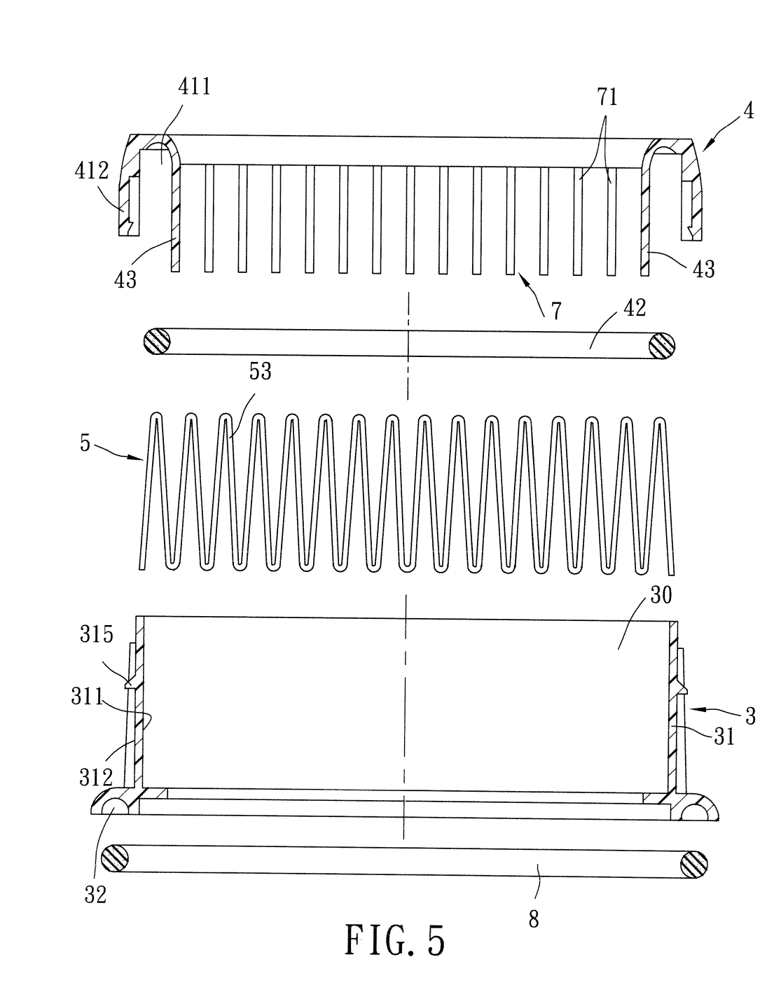

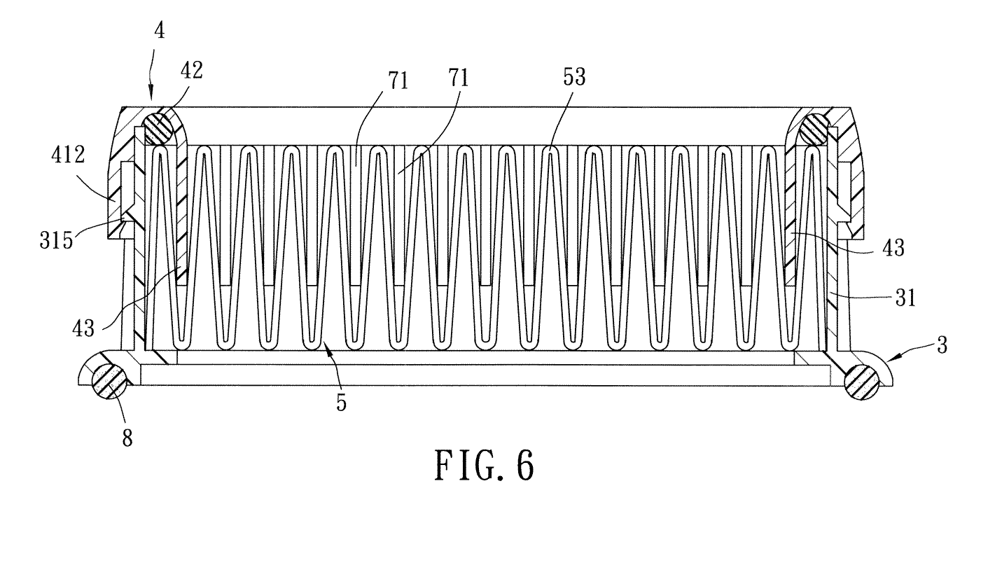

Referring to FIGS. 4 to 6, the second preferred embodiment of the air filter device of this invention differs from the first preferred embodiment in that a different air filter medium 5 is used, the loop-shaped retainer 4 further includes a plurality of limiting plates 43, and the air filter device further includes a spacer unit 7.

Compared to the air filter medium 5 in the first preferred embodiment, the corrugated air filter medium in this embodiment merely has a plurality of interconnected folded parts 53 without the side strips 55 and the sustaining strips 54. The limiting plates 43 are formed on two opposite sites of the loop-shaped frame 41, and cooperate with the surrounding wall 31 of the base 3 to confine a respective outermost one of the folded parts 53 of the air filter medium 5 therebetween. The number of the limiting plates 43 is not limited.

The spacer unit 7 includes two rows of spacer that are connected to two opposite sides of the looped-shaped frame 41 and that extend integrally from the loop-shaped retainer 4 and among the folded parts the air filter medium 5. Similar to the function of the sustaining strips 54 in the first preferred embodiment, the spacer ribs 71 of the spacer unit 7 are used for ensuring that the folded parts 53 are disposed each other. It should be noted that the number of the spacer ribs 71 in each of the rows is not limited.

By the design of the spacer unit and the limiting plates 43, the corrugated air filter medium 5 is maintained in a stretched state and placed stably inside the base 3 such that the air filter medium 5 is prevented from deformation or translocation during air filtration.

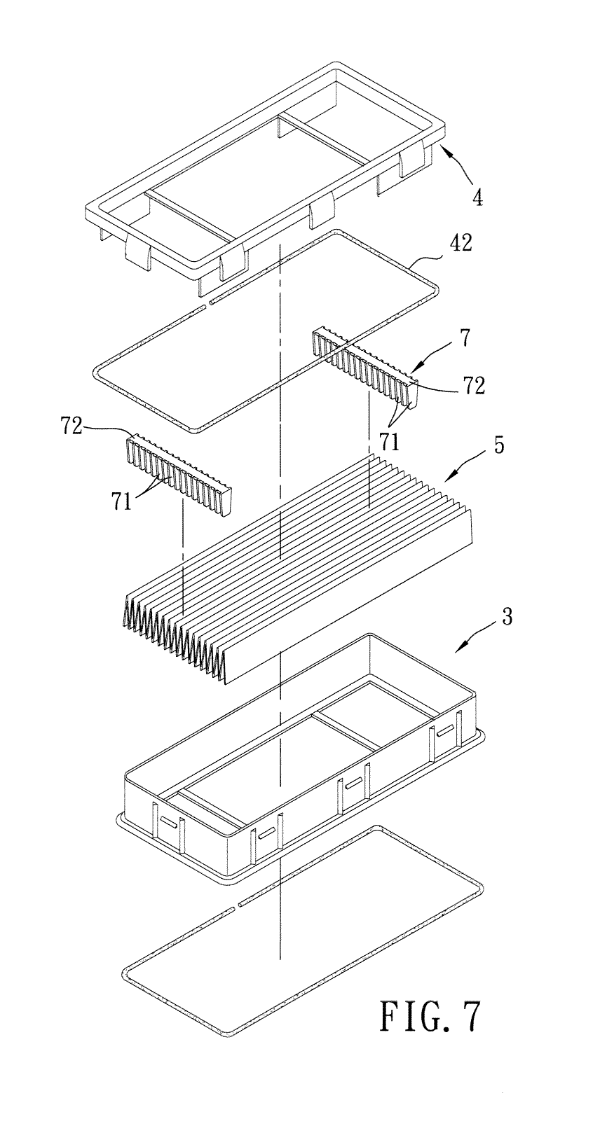

Referring to FIG. 7, the third preferred embodiment of the air filter device of this invention differs from the second preferred embodiment in that the spacer unit 7 is separated from the loop-shaped retainer 4 and includes two connecting strips 72 each of which is formed with the row of the spacer ribs 71. Each of the rows of the spacer ribs 71 extends integrally from the respective one of the connecting strips 72 and removably extends among the folded parts 53 of the air filter medium 5.

It should be noted that the number of the connecting strip 72 is not limited to two and could be adjusted based on actual requirements. Accordingly, the number of the rows of the spacer ribs 71 should be varied correspondingly.

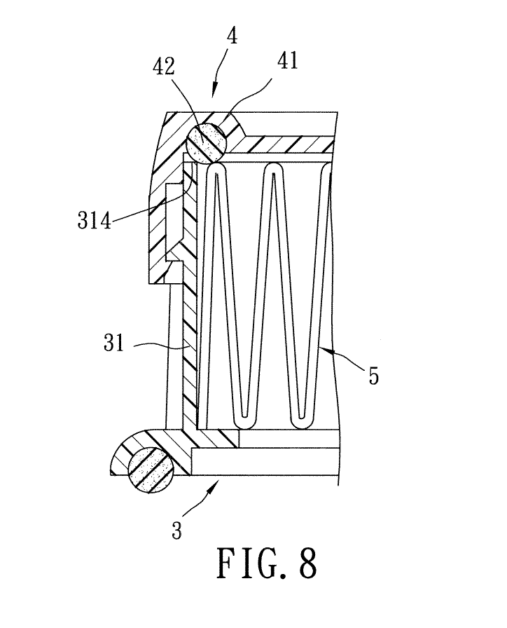

Referring to FIG. 8, the fourth preferred embodiment of the air filter device of this invention differs from the first preferred embodiment in that the air filter medium 5 used in this embodiment is the same as that of the second preferred embodiment, and the sealing strip 42 abuts against a top edge of the second end 314 of the surrounding wall 31 rather than the inner surface of the surrounding wall 31. Although the location of the sealing strip 42 is different, the sealing strip 42 is still received in the insert groove 411 and fitted between the loop-shaped frame 41 and the surrounding wall 31 such that air leakage therebetween may be prevented.

In conclusion, the air filter device of the present invention is environmental friendly because the air filter medium 5 is replaceable, thereby reducing the maintenance costs for the air filter device. By using the sealing strip 42, leakage of air may be prevented and the filtration efficiency of the air filter device of this invention may be improved.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An air filter device comprising:
an air filter medium;
a base including a surrounding all that has first and second ends and that defines a receiving space, said receiving space being open at said first and second ends of said surrounding wall, said air filter medium being placed removably in said receiving space, said first end of said surrounding wall being configured to support one side of said air filter medium; and
a loop-shaped retainer that engages removably said second end of said surrounding wall and that is disposed to abut against another side of said air filter medium in said receiving space.

2. The air filter device of claim 1, wherein said surrounding wall has an outer surface formed with a plurality of protrusions, and said loop-shaped retainer is formed with a plurality of resilient anchoring members that engage removably and respectively said protrusions.

3. The air filter device of claim 1, wherein said loop-shaped retainer includes a loop-shaped frame that engages removably said second end of said surrounding wall, and a sealing strip fitted between said loop-shaped frame and said surrounding wall.

4. The air filter device of claim 3, wherein said loop-shaped frame is formed with an insert groove that opens toward said surrounding wall and that has said sealing strip received therein, said second end of said surrounding wall pressing against said sealing strip.

5. The air filter device of claim 1, wherein said air filter medium is a corrugated filter medium having interconnected folded parts, and said air filter device further includes a spacer unit that extends into said receiving space and among said folded part of said air filter medium.

6. The air filter device of claim 5, wherein said spacer unit includes two rows of spacer ribs, each of said rows of said spacer ribs extending integrally from said loop-shaped retainer and extending among said folded parts of said air filter medium.

7. The air filter device of claim 5, wherein said spacer unit includes a connecting strip and a plurality of spacer ribs extending integrally from said connecting strip and extending among said folded parts of said air filter medium.

8. The air filter device of claim 5, wherein said loop-shaped retainer includes a plurality of limiting plates that cooperate with said surrounding wall to confine a respective outermost one of said folded parts of said air filter medium therebetween.
